(19) United States
(12) Patent Application Publication
(10) Pub. No.: US 2011/0266378 A1
(43) Pub. Date: Nov. 3, 2011

(54) PROCESS AND APPARATUS FOR THE HOMOGENIZATION OF FEED STOCK

(75) Inventors: Liisa Lehtinen, Lahti (FI); Risto Laaksonen, Lahti (FI)

(73) Assignee: UPM-Kymmene Corporation, Helsinki (FI)

(21) Appl. No.: 13/142,623

(22) PCT Filed: Dec. 29, 2009
(86) PCT No.: PCT/FI2009/051044

§ 371 Date: Jun. 29, 2011

(30) Foreign Application Priority Data
Dec. 29, 2008 (FI) 20086243

(51) Int. Cl. B02C 19/00; B02C 23/00; B01F 3/18

(52) U.S. Cl. 241/25; 366/348; 366/162.1; 366/163.1; 366/151.1; 241/291

(57) ABSTRACT

The invention relates to a process and apparatus for the homogenization of feed stock. According to the invention, solid stock material is mixed in at least two successive homogenization steps (1), wherein each homogenization step comprises at least two adjacent tanks (2), and the stock material is fed into adjacent tanks of a first homogenization step (IA), at least two stock flows are conducted out form each tank of each homogenization step, and at least one stock flow is conducted from each homogenization step into at least one tank (2) of the following homogenization step.

### FIELD OF THE INVENTION

The invention relates to a process as defined in the preamble of claim 1 and to an apparatus as defined in the preamble of claim 15 for the homogenization of feed stock, preferably for the manufacture of a composite material.

### BACKGROUND OF THE INVENTION

Known from the prior art are various processes for pretreating solid stock materials. Normally, the solid stock material is conducted into tanks, e.g. storage tanks, wherefrom the stock is fed to the manufacturing process e.g. after mixing carried out in the tanks.

A problem with the use of solid stock material, particularly recycled stock and natural materials, e.g. wood, flax, sisal fiber and other natural fibers, is their non-homogeneity and thereby great variation in quality in connection with the manufacturing process of a product.

In the manufacture of a composite material, mainly solid stock material is conducted to the manufacturing process normally from more than one tank. In the manufacture of a composite material, it is possible to use so-called intermediate tanks into which the stock is conducted before their feeding to the manufacturing process. In the tanks containing the stock, various mixing devices are often used to mix the stock to have an even mixture. Mixing commonly impairs the quality of the stock. A problem with the known processes for manufacturing a composite material is that particularly light and large particles of the stock, e.g. flaky chops, rise to the surface in the tank, and the heavy components deposit on the bottom of the tank. In this case, the stock to be fed to the manufacturing process is not homogenous.

In addition, the use of various intermediate tanks increases the manufacturing costs. Furthermore, if one has to select the stock material to be used, e.g. for quality reasons, it reduces efficiency of the recycling.

### OBJECTIVE OF THE INVENTION

The objective of the invention is to disclose a new type of a process and an apparatus for the homogenization of feed stock before the actual manufacturing process, e.g. manufacture of a composite material.

### SUMMARY OF THE INVENTION

The method and the apparatus according to the invention are characterized by what has been presented in the claims.

The invention is based on a process for the homogenization of feed stock. According to the invention, solid stock material is mixed in at least two successive homogenization steps, wherein each homogenization step comprises at least two adjacent tanks, in which process the stock material is fed into adjacent tanks of the first homogenization step, at least two stock flows are conducted out form each tank of each homogenization step, and at least one stock flow is conducted from each homogenization step into at least one tank on the following homogenization step.

The invention is specifically based on a process where stock feed is homogenized as well as possible to pretreat the stock material or materials and/or to manufacture a product such as a composite material.

Homogenization means in this connection mixing of the stock, i.e. stock material, so as to have a stock feed which is substantially of as uniform a quality as possible in the entire volume thereof.

The tank means in this connection any tank, silo, reactor or the like. In a preferred embodiment, the tank is a silo or a tank resembling a silo, in which case the stock material and the different-sized particles therein deposit in the tank and flow out of the tank evenly.

In one embodiment, the tank may be provided with scrapers or the like, e.g. to prevent arching of the material, and/or conveyor means, e.g. conveying screws, on the bottom of the tank.

In one embodiment of the invention, the stock material is fed into adjacent tanks of the first homogenization step, at least two stock flows are conducted out from each tank of each homogenization step, and the stock flows of each tank are conducted into adjacent tanks of the following homogenization step, in a preferred embodiment each stock flow into different adjacent tanks. In one embodiment, the stock flows of each tank are conducted into adjacent tanks of the following homogenization step so that at least one flow form each tank of the previous homogenization step is conducted into each tank of the following homogenization step.

In one embodiment of the invention, there are at least three successive steps. In one alternative embodiment, there are at least four successive steps. In one embodiment, there are 2 to 5 successive steps. Alternatively, there may be more of the successive steps.

In one embodiment of the invention, each step comprises at least three adjacent tanks. In one preferred embodiment, there are two adjacent tanks. In one embodiment, there are 2 to 4 adjacent tanks. Alternatively, there may be more of the adjacent tanks.

In one embodiment of the invention, the stock material is divided in each tank, by a method suitable for the purpose, into at least two flows in a desired ratio which may be a predetermined or a randomly determined ratio. In a preferred embodiment, the stock material is divided into as many stock flows as there are adjacent tanks in the following step. In one embodiment, the stock material is divided into two flows so that the proportion of the first flow is between 20 and 80 vol-%, in one embodiment between 40 and 60 vol-%, and the proportion of the second flow is between 20 and 80 vol-%, in one embodiment 40 and 60 vol-%. In one preferred embodiment, the stock material is divided into two flows so that the proportion of each flow is about 50 vol-%. In one preferred embodiment, the stock material is divided into three flows so that the proportion of each flow is between 30 and 36 vol-%.

The process according to the invention may be used to homogenize any substantially solid material, e.g. natural materials such as wood and plant fibers, grains, animal feeds, putty materials, mortars, materials of the concrete industry, various fillers and other bulk materials in which the stock components and/or densities of the materials vary, and to homogenize easily disintegrating solid materials.

In one embodiment, recycling material is used as the stock material.

In one embodiment of the invention, the stock material contains adhesive laminate waste. In one preferred embodiment, the stock material consists mainly of adhesive laminate waste. In one embodiment, the adhesive laminate waste is formed of adhesive material onto which a layer of glue has been provided, and fitted onto the layer of glue as a protective sheet is release material that can be easily released at the application site. In one preferred embodiment, the adhesive material and/or release material comprises a wood fiber based component and/or a plastic or a polymer based or other organic component. Also, the use of various inorganic materials is possible. In one embodiment, the adhesive and/or release material is a wood fiber based paper, paperboard or the like. In one embodiment, the wood fiber based paper, paperboard or the like comprises or is treated with plastic or polymer based material. In one embodiment, the adhesive and/or release material may be formed of substantially plastic or polymer based material. In one embodiment, the release material comprises a silicone based component. The release material is preferably siliconized.

In one embodiment, the stock material is crushed before the first step of the homogenization according to the invention. Crushing may be performed in one or 2 to 4 adjacent crushers, so that flows are conducted from each crusher to adjacent tanks of the first step of homogenization. In one embodiment, the stock material is provided in a predetermined particle size. In one embodiment, the stock material is provided in chops. In one embodiment, the mean size of the stock material chops is 1 to 10 mm, in one embodiment 2 to 5 mm and in one embodiment about 3 to 4 mm. In different adjacent crushers, the stock material may be chopped to different particle sizes. In different adjacent crushers, it is possible to crush different starting materials which are mixed in homogenization. In one embodiment, at least one crusher is arranged to crush adhesive laminate waste.

In one embodiment of the invention, homogenized stock flows are conducted after the last step to the manufacturing process of a composite material, e.g. manufacturing process of a wood-plastic composite material. In one embodiment, finished adhesive laminate products, waste material produced by them and/or in their manufacture may be used in the manufacture of the wood-plastic composite. In addition, waste material from production as well as recycling material from the upgrading step or end use applications may be used. In one embodiment, the adhesive laminate waste comes from adhesive laminate production which produces mainly production reject waste, edge trimming waste cut off from rolls and roll ends, from the adhesive laminate printing plant which produces mainly roll ends and adhesive material left over from die-cutting of stickers and labels as well as reject waste, and/or from the adhesive laminate end user customer who pastes the printed stickers and labels or the like on products. The waste obtained from the end user comprises mainly release material, reel ends and waste from the finished product.

In one embodiment of the invention, the homogenized stock flows are conducted after the last homogenization step to a pretreatment process of the stock for the manufacture of the composite material. In one embodiment, after the last homogenization step, all stock flows of adjacent tanks are conducted to the same pretreatment process. In one embodiment, a stock flow is conducted from each tank of the last step of homogenization to each concurrent pretreatment process.

In one embodiment, the homogenized stock flows are conducted after the last homogenization step to the actual manufacturing process of the composite material.

Preferably, additional material, additional plastic and/or additives are fed to the manufacturing process of the composite material and/or to the pretreatment process in addition to the homogenized stock material. In one embodiment, the additives are fed directly to the actual manufacturing process of the composite material. In one embodiment, at least part of the additional material, additional plastic and/or additives to be used is fed to the pretreatment process. In one embodiment, at least part of the additional material, additional plastic and/or additives to be used is fed to the actual manufacturing process of the composite material. Among the additives, e.g. the coloring agent, anti-mold agent and uv-stabilizer are added mainly at the actual manufacturing process of the composite material, and e.g. the anti-slip agent, fire retardant and adhesion promoter may be added either at the actual manufacturing of the composite material or at the pretreatment. As additional material, fibrous material, talc or the like may be fed to the stock material.

In one embodiment, additional plastic, which may be virgin or recycled plastic, is added to the stock material in the manufacture of the composite material and/or at the pretreatment. The composite material according to the invention may be manufactured with or without additional plastic. In one embodiment, e.g. polyolefin, polypropene, polyethene (HDPE, LDPE) or other suitable plastic or a mixture thereof is added to the adhesive laminate waste material as additional plastic to manufacture the wood composite material.

In one embodiment, the pretreatment process is selected from the group of a mixing process, a pelletizing process, a granulation process, an agglomerizing process and combinations thereof or any pretreatment process known per se.

In one embodiment of the invention, pneumatic conveyance, i.e. a pneumatic conveyor system, is used to transfer the stock material e.g. from storage or from the crusher to the first step of homogenization, from one step of homogenization to another and/or from the last step of homogenization to upgrading such as to the pretreatment process of the stock or to the manufacturing process. The manufacturing process may be for example a manufacturing process of composite material.

Pneumatic conveyance is a gentle method to transfer material and a relatively energy-efficient process. If agglomeration of the stock particles occurs due to moisture in one of the tanks, the agglomerates can be made to disintegrate preferably by the effect of the compressed air in pneumatic conveyance.

In one embodiment, the stock material may be conducted out from any step of homogenization and returned to earlier steps, conducted to a storage tank or conducted to upgrading such as to a pretreatment or manufacturing process. In one embodiment, the stock material may be conducted from any tank to the storage tank or returned to any step preceding the tank in question, e.g. to the first step of homogenization. In one embodiment, the stock material may be returned after the last step of homogenization back to be homogenized once again, if the stock material is not sufficiently homogenous.

In one embodiment of the invention, at least one stock flow is returned from at least one tank to a predetermined earlier homogenization step, preferably to a predetermined tank or tanks of an earlier homogenization step. In one embodiment, at least one stock flow is returned from at least one tank to the first homogenization step. In one embodiment, at least one stock flow is returned from at least one tank of the last homogenization step to the first step of homogenization.

In the process according to the invention, the tanks of the same step may be emptied at a different pace and/or at different rates.

In one embodiment, the amount of mixing of the stock material is greater than 1/32.

In addition, the invention is based on an apparatus for the homogenization of feed stock. According to the invention, the apparatus comprises at least two successive homogenization steps to mix the solid stock material, wherein each step comprises at least two adjacent tanks and lines between the tanks so that from each tank, the stock material can be conducted out in two stock flows, so that from each homogenization step, at least one stock flow can be conducted to at least one tank of the following homogenization step.

In one embodiment of the invention, the apparatus comprises lines for conducting homogenized stock material to the manufacture of a composite material and/or to a pretreatment device after the last homogenization step.

In one embodiment, the apparatus comprises feeding means to feed the stock material e.g. into tanks of the first homogenization step.

In one embodiment, the apparatus comprises return lines to return a predetermined stock flow to an earlier homogenization step. In one embodiment, the apparatus comprises lines to conduct any stock flow out from the homogenization process.

In one embodiment of the invention, the apparatus comprises a control apparatus to adjust and control the flows and homogenization of the stock material.

The process and the apparatus according to the invention provide considerable advantages as compared to the prior art.

The advantage of the invention is that homogenous stock feed is provided for the pretreatment or the manufacturing process of the stock, e.g. for the manufacture of a composite material. There are no distinguishable different-sized particles in the stock feed.

In the process according to the invention, it is not necessary to use mechanical mixing to treat the stock, so the quality of the stock is not impaired during mixing. Preferably, only settling and pneumatic conveyance are used in the process.

By the invention, an industrially applicable, easy, fast and useful manner of homogenizing stock material is achieved. The construction and operating costs of the process according to the invention are low.

The process and the apparatus according to the invention may be used in the manufacture of a composite material or alternatively in other manufacturing processes in which solid stock material is used as the stock.

### DETAILED DESCRIPTION OF THE INVENTION

In the following section, the invention will be described with a detailed example of an embodiment and with reference to the accompanying FIGURE.

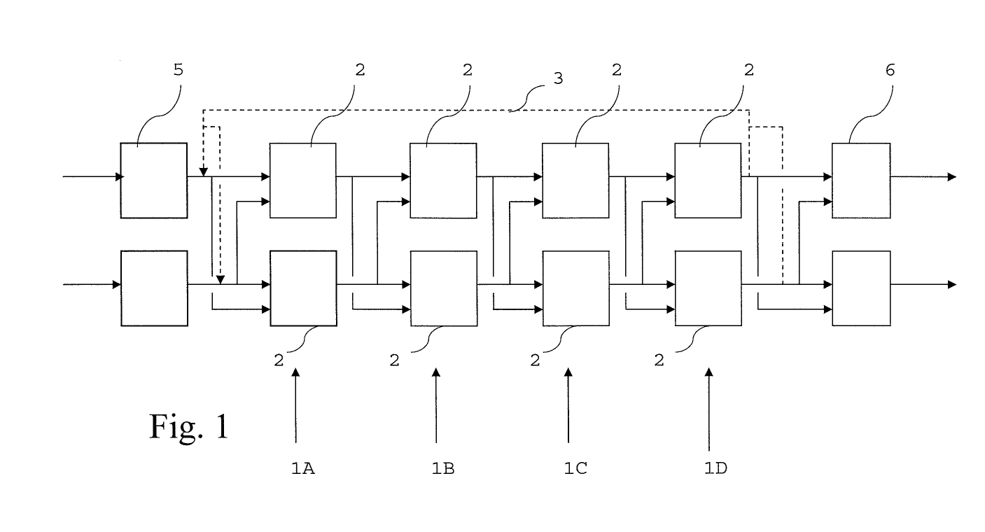

FIG. 1 presents one apparatus according to the invention for homogenizing stock material, which in this example consists of adhesive laminate waste. The apparatus comprises four successive homogenization steps 1A to 1D, each comprising two adjacent mixing silos 2. The size of the silo is about 35 m³. Adhesive laminate waste is fed to the first homogenization step 1A from two adjacent crushers 5, and from the last homogenization step 1D the stock material is conducted into two adjacent pretreatment mixers 6.

In the adjacent crushers 5, the adhesive laminate waste is chopped into a desired particle size which is preferably between 3 and 4 mm. In each crusher 5, the chop is divided in a manner known per se into two chop flows in a ratio of about 50/50 vol-% and conducted to adjacent silos 2 of the first homogenization step 1A, so that each crusher 5 provides one chop flow into each silo 2 of the first step 1A. In each adjacent silo 2 of each homogenization step 1A to 1D, the stock material is divided in a manner known per se into two exit flows in a ratio of 50/50 vol-%. From each silo 2, one flow is conducted to each adjacent silo of the following step. After the last homogenization step 1D, exit flows of the last homogenization silos 2 are conducted to adjacent pretreatment mixers 6, so that from each silo 2, one flow is conducted to each pretreatment device 6.

The flow rate of each exit flow that flows out of the silo is about 2700 m³/h. Provided on the bottom of the silos is a screw device which controls the exit flow and the rate of which may be adjusted. The adhesive laminate waste material is transferred by a pneumatic conveyor system (not shown in the FIGURE) from crushers 5 into silos 2, between silos and from silos 2 to pretreatment devices 6. The apparatus comprises a control apparatus (not shown in the FIGURE) which is a programmable adjustment system for adjusting different process parameters. The silos 2 are provided with overfill monitoring using an overfill sensor. For example, based on the overfill monitoring of the silo, it is possible to adjust, by the control apparatus, the screw device and/or the pneumatic conveyor to transfer the stock material and feed it into the silo of the next homogenization step.

In addition, the apparatus of FIG. 1 comprises return lines 3 (one of which is shown in the FIGURE by dashed line) to return a desired stock flow from any silo of any homogenization step 1A to 1D to any silo of the homogenization steps 1A to 1D. FIG. 1 shows lines 3 for returning the stock flows after the last homogenization step 1D to the first homogenization step 1A for re-homogenization or additional homogenization of the stock material.

Any devices known per se may be used as the screw device, pneumatic conveyor, overfill sensor, control apparatus and adjustment system.

In test runs it was discovered that the process and the apparatus according to the invention are well suited for the homogenization of stock feed.

The process and the apparatus according to the invention are applicable in different embodiments for use in homogenizing the most different kinds of solid stock materials.

The invention is not limited merely to the examples referred to above; instead, many variations are possible within the scope of the inventive idea defined by the claims.

1. A process for the homogenization of feed stock, wherein solid stock material is mixed in at least two successive homogenization steps, wherein each homogenization step comprises at least two adjacent tanks, in which process the stock material is fed into adjacent tanks of a first homogenization step, at least two stock flows are conducted out from each tank of each homogenization step, and at least one stock flow is conducted from each homogenization step into at least one tank on the following homogenization step.

2. The process according to claim 1, wherein it comprises at least three successive homogenization steps.

3. The process according to claim 1, wherein it comprises at least four successive homogenization steps.

4. The process according to claim 1, wherein each homogenization step comprises at least three adjacent tanks.

5. The process according to claim 1, wherein the stock material is fed into adjacent tanks of the first homogenization step, at least two stock flows are conducted out from each tank of each homogenization step, and the stock flows of each tank are conducted into adjacent tanks of the following homogenization step.

6. The process according to claim 5, wherein the stock flows of each tank are conducted into adjacent tanks of the following homogenization step, so that at least one flow from each tank of the previous homogenization step is conducted into each tank of the following homogenization step.

7. The process according to claim 1, wherein at least one stock flow is returned from at least one tank to a predetermined earlier homogenization step.

8. The process according claim 7, wherein at least one stock flow is returned from at least one tank to the first homogenization step.

9. The process according to claim 1, wherein in each tank, the stock is divided into at least two flows in predetermined ratios.

10. The process according to claim 1, wherein the homogenized stock flows are conducted after the last homogenization step to the manufacturing process of a composite material.

11. The process according to claim 1, wherein the homogenized stock flows are conducted after the last homogenization step to a pretreatment process for the stock to manufacture the composite material.

12. The process according to claim 1, wherein the stock material contains adhesive laminate waste.

13. The process according to claim 1, wherein the stock material is crushed before the first step of homogenization.

14. The process according to claim 1, wherein pneumatic conveyance is used to transfer the stock material.

15. An apparatus for the homogenization of feed stock, wherein the apparatus comprises at least two successive homogenization steps to mix the stock material, wherein each step comprises at least two adjacent tanks and lines between the tanks, so that from each tank, the stock material can be conducted out in two stock flows, so that from each homogenization step, at least one stock flow can be conducted to at least one tank of the following homogenization step.

16. The apparatus according to claim 15, wherein the apparatus comprises 2 to 5 successive homogenization steps.

17. The apparatus according to claim 15, wherein each homogenization step comprises 2 to 4 adjacent tanks.

18. The apparatus according to claim 15, wherein the apparatus comprises lines for conducting the homogenized stock material to the manufacture of a composite material and/or to a pretreatment device after the last homogenization step.

19. The apparatus according to claim 15, wherein the apparatus comprises at least one crusher for crushing the stock material before homogenization.

20. The apparatus according to claim 19, wherein at least one crusher is arranged to crush adhesive laminate waste.

21. The apparatus according to claim 15, wherein the apparatus comprises a pneumatic conveyance system to transfer the stock material.

22. The apparatus according to claim 15, wherein the apparatus comprises a control apparatus to adjust and control the flows and homogenization of the stock material.
